(19) United States
(12) Patent Application Publication
(10) Pub. No.: US 2014/0225897 A1
(43) Pub. Date: Aug. 14, 2014

(54) METHOD AND APPARATUS FOR ACTIVITY LEVEL VISUALIZATION IN AN ELECTRONIC CALENDAR

(71) Applicant: BLACKBERRY LIMITED, Waterloo (CA)

(72) Inventors: JACOU SARRAZIN, Repentigny (CA); VITALIY BELITSKY, Montreal (CA)

(73) Assignee: BLACKBERRY LIMITED, Waterloo (CA)

(21) Appl. No.: 14/255,364

(22) Filed: Apr. 17, 2014

Related U.S. Application Data
(63) Continuation of application No. PCT/CA2012/050092, filed on Feb. 17, 2012.
(60) Provisional application No. 61/550,029, filed on Oct. 21, 2011.

(51) Int. Cl. G06T 11/00; G06T 3/40; G06Q 10/10

(52) U.S. Cl. CPC G06T 11/001; G06Q 10/1093; G06T 3/40
USPC 345/467

(57) ABSTRACT

The present document describes a system and method of managing and viewing calendar data. Calendar data may include, for each of a plurality of calendar events, data items indicating at least a date of the event. According to some example embodiments, a visual indicator is displayed for each date in a date range. The visual indicator may be generated as a function of the number of events or the duration of time of events for the day. The visual indicator may include a font size and/or bold type of a numerical day displayed. Thus, in some example embodiments, the size and bold type of the numerical day may indicate to a user the relative activity level of the individual days of the date range. The visual indicator may also indicate a conflict between scheduled events.

### RELATED APPLICATION

The present patent application is a continuation of PCT International Application No. PCT/CA2012/050092 filed Feb. 17, 2012, which claims the benefit of U.S. Provisional Patent Application Ser. No. 61/550,029, filed on Oct. 21, 2011, the entire contents of both of which are incorporated herein by reference.

### FIELD

The subject matter disclosed generally relates to the field of computer networking and methods of calendar sharing and time management.

### BACKGROUND

Conventional time and contact management tools may allow a user to synchronize a portable device with a home computer or home network system, whereby calendar and time information available on the portable device may be browsed and viewed on the home computer and vice-versa.

With conventional time management tools, the user may browse the calendar manually and/or use keywords when the user is looking for a certain event.

### BRIEF DESCRIPTION OF THE DRAWINGS

Some example embodiments will now be described in greater detail with reference to the accompanying diagrams, in which:

FIG. 1 is a diagram illustrating an example system which may include apparatuses according to some example embodiments;

FIG. 2 is a flowchart of an example processor-implemented method of displaying a visual indicator for days in a date range in an electronic calendar according to some example embodiments;

FIG. 3 is a block diagram of an example apparatus that may display a visual indicator for days in a date range in an electronic calendar in accordance with the method of FIG. 2;

FIG. 4 is a flowchart of another example processor-implemented method of displaying a visual indicator for days in a date range in an electronic calendar according to some example embodiments;

FIG. 5 is a block diagram of an example apparatus that may display a visual indicator for days in a date range in an electronic calendar in accordance with the method of FIG. 4;

FIG. 6 is a flowchart of an example processor-implemented method of displaying a visual indicator for days in a date range in an electronic calendar in accordance with some example embodiments;

FIG. 7 is a block diagram of an example apparatus that may display a visual indicator for days in a date range in an electronic calendar in accordance with the method of FIG. 6;

FIG. 8 illustrates an example user interface for displaying calendar information in accordance with some example embodiments;

FIG. 9 illustrates another example user interface for displaying calendar information in accordance with some example embodiments

FIG. 10 illustrates another example user interface for displaying calendar information in accordance with some example embodiments;

FIG. 11 illustrates another example user interface for displaying calendar information in accordance with some example embodiments;

FIG. 12 illustrates another example user interface for displaying calendar information in accordance with some example embodiments;

FIG. 13 illustrates another example user interface for displaying calendar information in accordance with some example embodiments;

FIG. 14 illustrates another example user interface for displaying calendar information in accordance with some example embodiments; and

FIG. 15 is a block diagram of an example mobile device.

### DETAILED DESCRIPTION

According to one example embodiment there is provided, a method implemented by a processor, including: for each date in a date range, displaying a visual indicator as a function of calendar data, the calendar data including, for each of at least one calendar event: at least respective data items indicating a date for the calendar event and a total time occupied by the event.

In some example embodiments, the visual indicator includes, for each date, a respective font setting of a respective numerical day, the font setting being determined as a function of the calendar data.

In some example embodiments, for each numerical day, the respective font setting includes a respective font size.

In some example embodiments, for each numerical day, the respective font setting includes a respective bold type.

In some example embodiments, displaying the visual indicator as a function of the calendar data includes displaying the visual indicator as a function of a number of events for the date.

In some example embodiments, displaying the visual indicator as a function of the calendar data includes displaying the visual indicator as a function of the total time occupied by the events for the date.

In some example embodiments, displaying the visual indicator as a function of calendar data includes: generating an index as a function of the calendar data; and displaying the visual indicator as a function of the index.

In some example embodiments, generating the index as a function of the calendar data includes generating the index as a function of at least one of: a number of events for the date; and the total time occupied by the events for the date.

In some example embodiments, the calendar data further includes, for each calendar event: a respective data item indicating an availability factor of the event.

In some example embodiments, displaying the visual indicator as a function of the calendar data includes displaying the visual indicator as a function of a total time occupied by events for the date and the availability factor of each event for the date.

In some example embodiments, the availability factor indicates that the event is designated as one of free, busy, tentative and out-of-office.

In some example embodiments, displaying the visual indicator as a function of the calendar data includes displaying the visual indicator as a function of a total time occupied by the events designated as either busy or tentative.

In some example embodiments, the calendar data further includes, for each of at least one calendar event: at least one data item indicating at least one participant for the event.

In some example embodiments, the method further includes, for each date, displaying a participant indicator generated as a function of a number of participants of events for the date.

In some example embodiments, the at least one calendar event includes a plurality of calendar events, and the visual indicator includes a conflict indicator that indicates a conflict between two or more of the plurality of calendar events.

In some example embodiments, the method further includes receiving the calendar data from a database.

In some example embodiments, the calendar data that is received includes a portion of available calendar data.

In some example embodiments, the portion of the available calendar data includes data items upon which the visual indicator is based.

In some example embodiments, the calendar data further includes, for each calendar event: a respective data item an availability factor of the event, and the portion of the available calendar data includes the data items indicating: the date of the event; the total time occupied by the event; and the availability factor of the event.

In some example embodiments, the method further includes receiving an indication of a selected date in the date range and receiving additional data items for events for the selected date.

According to another example embodiment there is provided an apparatus, including: a processor configured to, for each date in a date range, generate a visual indicator as a function of calendar data; and a display displaying the visual indicator, the calendar data including, for each of at least one calendar event: at least respective data items indicating a date for the calendar event and a total time occupied by the event.

In some example embodiments, the visual indicator includes, for each date, a respective font setting of a respective numerical day, the font setting being determined as a function of the calendar data.

In some example embodiments, for each numerical day, the respective font setting includes at least one of a font size and a bold type.

In some example embodiments, the calendar data further includes, for each calendar event: a respective data item indicating an availability factor of the event, and, displaying the visual indicator as a function of the calendar data includes displaying the visual indicator as a function of a total time occupied by the events for the date and the availability factor of each event for the date.

According to another example embodiment there is provided a computer-readable medium having processor-executable instructions stored thereon that, when executed by a processor, cause the processor to implement a method including: for each date in a date range, displaying a visual indicator as a function of calendar data, the calendar data including, for each of at least one calendar event: at least respective data items indicating a date for the calendar event and a total time occupied by the event.

Other example embodiments and features of the disclosure will become apparent, to those ordinarily skilled in the art, upon review of the following description of some specific example embodiments. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

Some example embodiments of the present disclosure relate to methods, apparatuses and systems for managing and viewing calendar data. For example, some example embodiments of the present disclosure relate to methods apparatuses and systems for presenting calendar data to a user such that the user can easily assess how busy or how full their schedule for different dates.

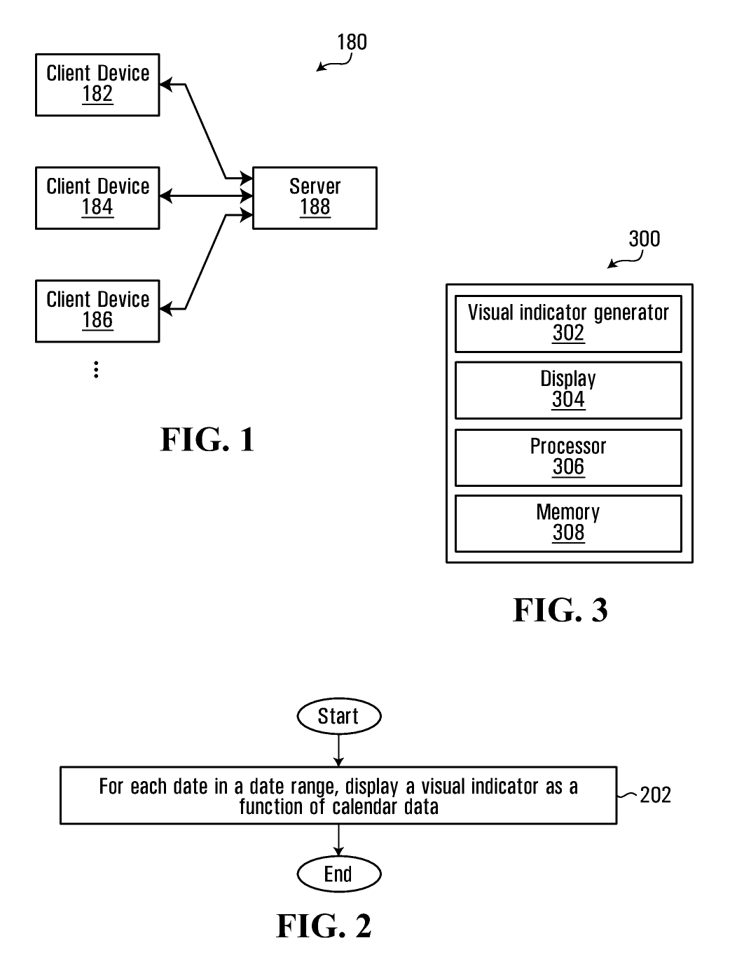

FIG. 1 is a diagram illustrating an example system 180 which may include apparatuses according to some example embodiments and in which the methods according to some example embodiments of the disclosure may be performed. FIG. 1 shows a plurality of client devices, including client devices 182, 184 and 186, and a server 188. The system 180 may include more or fewer client devices. Each of the client devices 182, 184 and 186 is in communication with the server 188. For example, communication with the server 188 may be through a local network or through the Internet. The server 188 may also be in communication with one or more other servers (not shown) or other network components (not shown).

An electronic calendaring application is run on the client devices 182, 184 and 186, on the server 188, or on both. The client devices 182, 184 and 186 and/or the server 188 may access and/or store calendar data associated with the calendaring application. For example, if the calendaring application is run by the server 188, then the server 188 may transmit/receive electronic calendar data to/from one or more of the client devices 182, 184 and 186. Electronic calendar information may be stored and processed at either the client devices 182, 184 and 186, or the server 188, or both. The server 188 may receive calendar information or other information from sources external to the system 180. For example, the server 188 may be connected to the Internet such that calendar information may be retrieved from LINKEDIN™, MICROSOFT OUTLOOK™, social networking website applications, etc.

The term “client device” includes, but is not limited to, personal computing devices, user terminals, and other similar computing devices. A client device may also be a mobile communication device. A mobile communication device may communicate with the server directly through a network. A mobile communication device may also communicate with a computing device (such as a desktop or laptop computer, for example) that, in turn, communicates with the server. For example, a mobile communication device may be “synchronized” with a computer. Synchronizing may include sending data, such as electronic calendar data, to the computer and/or receiving data from the computer, such that the mobile communication device and the computer have the same data.

In some example embodiments, there may be multiple servers in communication. For example, the server 188 may be in communication with servers hosting data and/or applications such as LINKEDIN™, BING NEWS™, etc.

Calendar data may include data for a plurality of calendar events. Calendar events are any scheduled occurrence, either future or past. Examples of calendar events include meetings, appointments, phone, video or internet conferences, birthdays or other all day events, etc. Each calendar event is defined by a number of data items. Each data item defines a characteristic of the respective event. For example, the data items defining a given calendar event may include the type of the meeting (e.g. physical meeting, online meeting, video conference, phone conference, lunch, coffee break etc.); an identification of the person(s)/participant(s) associated with the event; a duration of the event; date of the event; meeting notes; and a location of the event. Example embodiments are not limited to these examples of data items.

The calendar data may be classified or organized according to a plurality of event data categories. Accordingly, each data item in calendar data may be a data item of one of the calendar events classified into one of the event data categories. A data item classified into an event data category is said to correspond to that event data category.

Event data categories define categories of event characteristics. In some example embodiments, event data categories include: meeting type data; participant(s) data; date data; duration data; and location data. Any other characteristics of a calendar event may also be used as an event data category. In some example embodiments, a user may define the event data categories to be included in the calendar data.

As mentioned above, each data item in calendar data may be a data item of one of the calendar events classified into one of the event data categories. For example, if one event data category is meeting type data, then a corresponding data item for each calendar event defines the type of meeting for that event. For example, the corresponding data item for a first event may be “personal”, while the corresponding data item for a second event may be “business”. Other meeting types may include “external”, “internal”, “lunch”, “phone conference” etc. As another example, data items corresponding to the “participant” event data category may identify the specific participants expected to participate in the respective calendar events. As will be appreciated by one skilled in the art, the specific form and content of calendar data may vary, and example embodiments are not limited to any of the particular event data categories listed above. In some example embodiments, the event data categories under which the data items are organized may include categories of data not specifically identified herein.

According to some example embodiments, a user interface may display an indicator, for each day of a date range, of a user's activity level according to the events scheduled for that day. The term “activity level” used herein generally refers to how busy or occupied a user's day is. For example, a user's activity level may refer to either the number of events for a day or to a total amount of time occupied by events. A user may then assess their expected activity level or availability for a given date, or over some or all of the date range, by simply viewing the respective visual indicators rather than by looking through a list of the events for each day. A visual indicator may be any visible identifying feature shown on a display. Examples of visual indicators are described below.

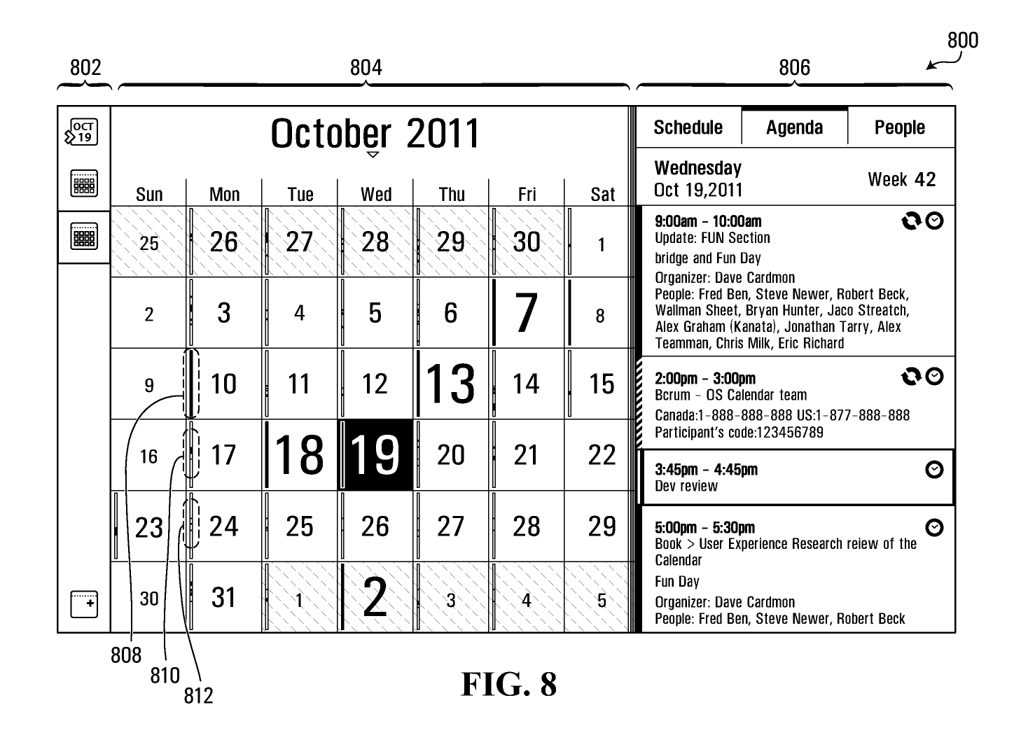

The date range could be a month in some embodiments, although other date ranges (for example, weekly, bi-weekly, yearly etc.) are possible. Monthly calendars are typically represented by a grid of days for the month, each day of the month having a respective numerical representation (i.e. a number representing the day of the month). For simplicity, the numbers representative of the days of the month will be referred to as “numerical days” herein. The numerical days are typically displayed in columns under the associated day of the week. For example, the numerical days may be listed under days of the week from Sunday to Saturday. However, other start and end days of the week (e.g. Monday to Sunday) are also possible. The start and end dates of the week may be customizable in some example embodiments. Examples of monthly calendar formats according to some embodiments are discussed below with respect to FIGS. 8 to 14. More generally, any format for arranging and displaying numerical days in a calendar may be use in some example embodiments.

The calendar data, in some example embodiments, may be classified and stored according to Internet Calendaring and Scheduling Core Object Specification (iCalendar) RFC 5545 and RFC 2445 standards. The entire contents of the RFC 5545 and RFC 2445 standards are incorporated herein by reference. These standards dictate, among other things, how to accept meetings, invite others, etc.

FIG. 2 is a flowchart of an example processor-implemented method of displaying numerical days for a date range according to some example embodiments. The method shown in FIG. 2 may be performed by an apparatus. For example, the method shown in FIG. 2 may be performed by a client device, such as any one of the client devices 182, 184 and 186 of FIG. 1. At block 202, for each date in a date range, a visual indicator is displayed as a function of calendar data. The calendar data includes, for each of at least one calendar event: at least respective data items indicating a date for the calendar event and a total time occupied by the event.

In some example embodiments, the visual indicator is a text or font setting (such as the font size or bold type) of the displayed numerical day. The term “font setting” refers to any characteristic of a font that defines or alters its appearance. As used herein, the “font size” of a numerical day refers to the size of the number (i.e. the numerical day) displayed in a calendar for a given day. Specifically, in some example embodiments, the font size of a displayed numerical day is determined as a function of the calendar data. For example, as will be explained below, the font size of the numerical day may be larger for days that a user is busier than for days where the user is less busy. Thus, a user may look at a calendar including numerical days (e.g. a monthly calendar view) and quickly assess their relative activity level or availability for different days. Example embodiments are not limited to the visual indicator being the font size of the numerical day. In other embodiments, other text or font settings (such as color, bold type, italics, etc), may be used as the visual indicator.

The visual indicator, such as the font size, may range from a minimum to a maximum setting (e.g. minimum font size and maximum font size). In some embodiments, the minimum setting may be used for days having an activity level that is at or below a minimum threshold, and the maximum setting may be used for days that meet or exceed a maximum activity level threshold. For example, if the threshold for the maximum setting is 12 hours of busy time during a day, there may not be a change in the visual indicator displayed for that day if the user is busy during 15 hours or busy during 24 hours. Thus, if the visual indicator is a font size, for example, the font size may reach a maximum size and the font size may not increase if the user is busy during more time than the maximum threshold. The user may still easily assess whether they have a light day or a busy one, although the visual indicator may have a maximum and minimum setting.

The visual indicator may vary between the maximum and minimum settings for activity levels that are between the maximum and the minimum thresholds. For example, if the visual indicator is the font size of the numerical day, the font size may have a proportional relationship to the activity level for a given day. In one example, the visual indicator is a font size and the font size increases as the amount of busy time during the day increases. However, other relationships between the visual indicator and the calendar data are possible, and embodiments are not limited to those in which a font size increase is used to indicate that one day is busier than another.

FIG. 3 is a block diagram of an example apparatus 300 that may perform the method of FIG. 2. The apparatus 300 includes a visual indicator generator 302, a display 304, a processor 306 and a memory 308. The visual indicator generator 302 generates, for each date in a date range, a visual indicator as a function of calendar data. The display 304 displays the visual indicator for each date. The visual indicator generator 302 may be implemented as a memory (such as the memory 308) containing instructions for execution by a processor (such as the processor 306), by hardware, or by a combination of instructions stored in a memory and additional hardware, to name a few examples. As with other example embodiments described herein, the visual indicator may be a font size and/or bold type of the numerical day displayed for each date, determined as a function of the calendar data (e.g. number of events, duration of events etc.).

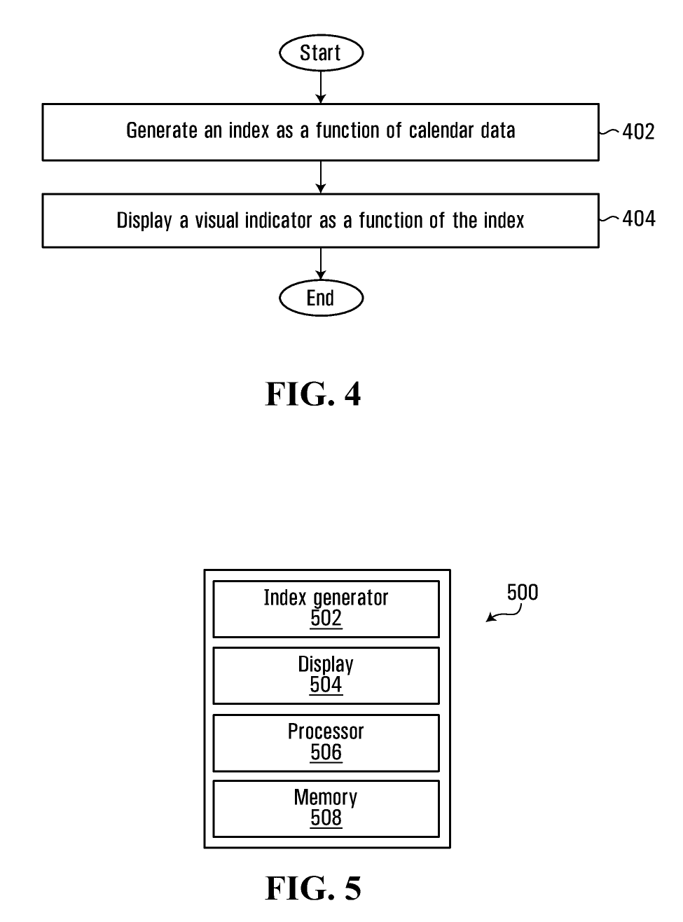

FIG. 4 is a flowchart of another example processor-implemented method of displaying a visual indicator for days in a date range according to some example embodiments. At block 402 an index is generated, for each date in a date range, as a function of calendar data. The index may be a numerical value. The calendar data includes, for each of at least one calendar event: at least a respective data item indicating a date for the calendar event. At block 404, for each date in the date range, a visual indicator for each date is displayed as a function of the respective index. For example, a range of possible index values may correspond to respective possible visual indicator settings (e.g. font sizes). The index may be generated by use of a table. The table may include a selection of possible indexes and a selection of criteria for each possible index. In an example, the table may indicate that one hour or less busy time corresponds to an index of 1. More than one hour, but less than two hours of busy time may correspond to an index of 2, and so on. Each index may correspond to a particular visual indicator setting or feature (such as a specific font size). For example, an index of 1 may correspond to a 20 point font size. An index of 2 may correspond to a 24 point font size, and so on. As will be apparent to one skilled in the art, various means of generating a visual indicator as a function of calendar data may be implemented, and embodiments are not limited to the specific examples described herein.

The method described herein with reference to FIG. 4 may be performed by a client device. In other example embodiments, calendar data processing, including generating an index for each date may occur at a different network component such as a server. In such example embodiments, the index for each date may be transmitted to a client device.

FIG. 5 is a block diagram of an example apparatus 500 that may display a visual indicator for days in a date range in accordance with the method of FIG. 4. The apparatus may be, for example, a client device such as any one of the client devices 182, 184 and 186 of FIG. 1. The client device may be a mobile communication device. The apparatus 500 includes an index generator 502, a display 504, a processor 506 and a memory 508. The index generator 502 generates, for each date in a date range, an index as a function of calendar data. The display 504 displays, for each date in the date range, a visual indicator as a function of the index. The index generator 502 may be implemented as a processor configured to perform its functions described above. The index generator 502 may be implemented as a memory (such as the memory 508) containing instructions for execution by a processor (such as the processor 506), by hardware, or by a combination of instructions stored in a memory and additional hardware, to name a few examples.

In some example embodiments, the index is generated as a function of the number of calendar events in a day. The index in this case may, for example, simply be a value corresponding to the number of events. The index may have a one-to-one relationship with the number of events where each different number of events corresponds to a different index. Alternatively, the index may be generated according to a table where groups of possible numbers of events are each associated with a corresponding index value. Example embodiments are not limited to a particular function for generating the index. The index value may increase as the number of events for a date increases.

In some example embodiments, the calendar data includes, for each of at least one calendar event, respective data items. The data items for an event may indicate a start time of the event and a stop time of the event. Thus, the duration of each event may be calculated. In some embodiments, the data items indicate a total duration of the event (or a total time occupied by the event), and, thus, the duration may not need to be calculated. The index for each date may then be generated as a function of the total duration of the events for the date. For example, a first index may be generated for a date where five hours are scheduled for calendar events, and a second index may be generated for a date where only two hours are scheduled for calendar events. In this case, the second index may be smaller than the first index, although the function for generating the index may vary.

Some example embodiments do not necessarily require that an index be generated. Rather, in some example embodiments, the visual indicator is generated directly as a function of calendar data, using methods similar to those described above or below for generating an index.

In still further example embodiments, the calendar data further includes, for each of at least one calendar event, a respective data item indicating an availability factor of the event. The term “availability factor” used herein refers to an actual or expected availability of the user during the event. The availability factor may be assigned to the calendar event by a user. For example, in some example embodiments, the availability factors include one of “free”, “busy”, “tentative” and “out-of-office. In some example embodiments, a user may “tag” each event with an availability factor. “Tagging” an event, in some example embodiments, includes receiving input from a user, where the input is used to create or modify a data item that is stored in the calendar data for the tagged event. Calendar data for events may include a default availability factor (e.g. busy) that may be modified the user. A finite number of availability factors may be available. Calendar events tagged as “free” events may be events that do not specifically restrict a user's activity during the time of the event. Possible examples of calendar events that may be designated as “free” include, but are not limited to, birthdays, anniversaries, work-from-home days, travelling days (a user may still communicate if traveling by train, for example) etc. Calendar events that may be designated as “busy” may be events that do restrict a user's activity during the time of the event and may include, but are not limited to, meetings, telephone conferences, various personal activities, etc. Calendar events may be designated as “tentative”, for example, if it is not yet certain whether the event will occur, or if the user will attend the event. Events maybe designated as “out-of-office”, for example, if the user plans to be away from their usual place of work for the duration of the event. Examples of possible “out-of-office” events include vacation days, work breaks, days where the user is working away from the office, etc.

In some example embodiments, the methods described herein further include receiving a user-designated tag and assigning the tag to each calendar event in the user's calendar. Events may be tagged with information other than an availability factor. For example, an event may have more than one tag. For example, a certain client meeting may be tagged “work” and may also be tagged “out of the office meeting”. Embodiments are not limited by particular types of data items that may be added or modified based on user input.

The visual indicator may be generated as a function of the availability factor of one or more events. In some embodiments, the visual indicator is generated as a function of a duration of the events for the date and the availability factor of each event for the date. For example, in some example embodiments, only the durations of calendar events designated as “busy” or “tentative” are considered, and calendar events designated as “free” or “out-of-office” do not contribute to the generation of the visual indicator. In other example embodiments, the durations of all events except for “free” events may be considered. In other example embodiments, only “busy” events are used to generate the visual indicator. For example, in embodiments where an index is calculated, upon which the visual indicator is based, the calculation of the index may only take certain types of events into account. The visual indicator may be displayed as a function of the index for each day. Example embodiments are not limited to a particular function for generating the visual indicator. A user may be able to provide input customizing how the visual indicator is generated, including which types of events are considered for the purpose of generating the visual indicator.

As noted above, the visual indicator may be the font size of the numerical days displayed. In some example embodiments, the visual indicator includes other font features, such as bold type, that are determined as a function of the index. The numerical day may be emboldened (or in other words made bold) dynamically (i.e. varying font bold type or boldness level) or have a larger font depending on the number and/or duration of “busy” events each specific day. In some example embodiments, if a person has no meetings on a specific date, the numerical day of that date is not made bold and the font is a regular size. As the day has more busy events, then the numerical day displayed in the calendar may be proportionally bolded and may have an increased font size.

In some embodiments, the index generated from the calendar data and the font size may be related such that the font size of numerical days increases with the number of events, the total duration of events, or only the total duration of events designated as “busy” or “tentative”. By relating the font size of the numerical days of the calendar in this fashion, a user may quickly identify days in which they are busy. It may be easier to read the numerical days having a larger relative font size than the numbers which have a smaller relative font size. The bold type of the numerical days may similarly make certain days (e.g. days in which the user is more busy) easier to read.

In addition to using a visual indicator to represent the level of activity on a specific day, part of the complexity in some example embodiments, is to retrieve the data for an entire month of activity and compute the size of font and bold type for each day. In order to reduce processing complexity in the user interface, only a portion of calendar data may be retrieved as discussed below.

In some example embodiments, the calendar data may be received from a database. In some embodiments, prior to receiving the calendar data from the database, the calendar data is requested. The database may be part of the same apparatus that is generates the index as a function of the calendar data (for example, a client device). In some example embodiments, only the calendar data necessary for generating the index is received and/or requested. Thus, the received calendar data may be only a portion of the total available calendar data in the database. For example, if the visual indicator is generated for each date in a range as a function of the total duration of events for the date, only the data items indicating the date, start and end times (or duration), and the availability factors of the calendar events occurring within the date range may be received and/or requested. Thus, the computational complexity and processor power required to calculate the index for each date in the date range may be reduced and the process of calculating and drawing of the monthly calendar may not be slowed down. However, in other example embodiments, the visual indicator may be generated from calendar data that includes more than the minimum necessary data items. For example, the entire available calendar data in a database could be received and/or requested for the purpose of generating the visual indicator for each date.

In some example embodiments, calendar data is be received and/or requested from one than more electronic calendar. Multiple calendars may be synchronized at the client device. Thus, the activity level indicated by the visual indicator may take into considerations events from each calendar.

As will be explained below, a calendar display including numerical days with a visual indicator as described above may further include additional visual indicators that provide additional information to a user (such as the number of participants for all events in a day).

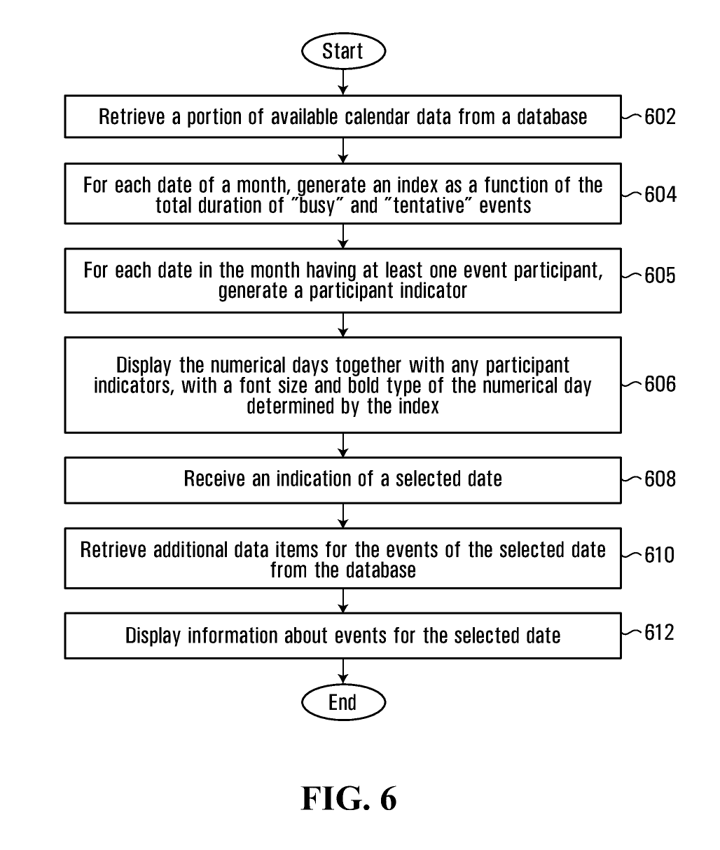

FIG. 6 is a flowchart of an example processor-implemented method of displaying numerical days for a date range in accordance with some example embodiments. At block 602, a portion of available calendar data is received from a database. In this example, the data is received from a local database. However, the data may also be received from an external or remote database. For example, a client device may request the calendar data from a server. The received calendar data may have been requested prior to being received. In this example, the received calendar data includes the data items indicating the date, duration, and availability factor for each calendar event in a given calendar month (e.g. January, February, etc). The received calendar data, in this example, also includes data items indicating participants of events.

At block 604, for each date in the given month, an index is generated as a function of the total duration of events for which the availability factor is either “busy” or “tentative”. In this example, the index is proportional to the total duration of such events. In other example embodiments, for each date in the given month, an index is generated only as a function of the total duration of events for which the availability factor is either “busy” or “tentative”. However, in other embodiments, the index is not generated as a function of the availability factor. Rather, the index may be generated as a function of one or more of: a number of events; and a total duration of events. In other embodiments, the index is generated as a function of a number and/or total duration of events as well as the availability factor of one or more events. More generally, embodiments are not limited an any particular method for generating the index or for generating the visual indicator as a function of the calendar data.

In the example method shown in FIG. 6, additional visual indicators are generated and displayed. As an example, at block 605, a participant indicator that indicates the total number of participants is generated (from the data items indicating participants for the events) for each date having at least one participant. The visual indicator may be, for example, an icon representing “participants” generally and an adjacent number representing the total number of participants. Other visual indicators are also possible.

At block 606, for each date in the given month, the numerical day is displayed where the font size and bold type of the numerical day is determined by the index. Any participant indicators are also displayed at block 606. For example, the font size and bold type may be determined from a table dictating a relationship between possible indices and bold types. Other visual indicators, such as color, a line or bar (such as for example bars 808-812 of FIG. 8) of varying length adjacent to each numerical day, or other visual indicators may be implemented as well in some example embodiments. Calendar data received from the database at block 602 may be limited to the data items necessary to determine the visual indicators actually displayed (displayed at block 606).

A user may want to view additional details than for particular date or range of dates. For example, if a monthly calendar view having numerical days of various size and boldness is displayed, a user may wish to select a view showing more detail concerning events for a given day. Thus, in accordance with some example embodiments, at block 608, an indication of a selected date is received. For example, the selected date may be received from a user.

At step 610, additional data items for the events of the selected date are received from the database. For example, additional details such as event locations, event types, etc. may be received.

At step 612, information about events for the selected date is displayed. Information about events may include statistics information, participant information, or any other calendar information that may be stored or generated and for the selected date. For example, statistics data may be generated as a function of calendar data. Statistics data is produced by an analysis and/or interpretation of the calendar data. Statistics data may include one or more quantities generated as a function of the calendar data. For example, the one or more quantities may include a number, percentage, or list of events and/or data items meeting a certain criteria. Statistics data may further include the data items of all events meeting a certain criteria. Statistics data may describe a correlation (e.g. dependency or relationship) between one or more sets of the data items in the calendar data. For example, statistics data may include the frequency that events within a certain date range occur at a particular location. Example embodiments are not limited to any particular type of statistics data. The term “statistics data” as used herein may also include analytical information such as information related to productivity, goals etc. The statistics data may be generated using a processor.

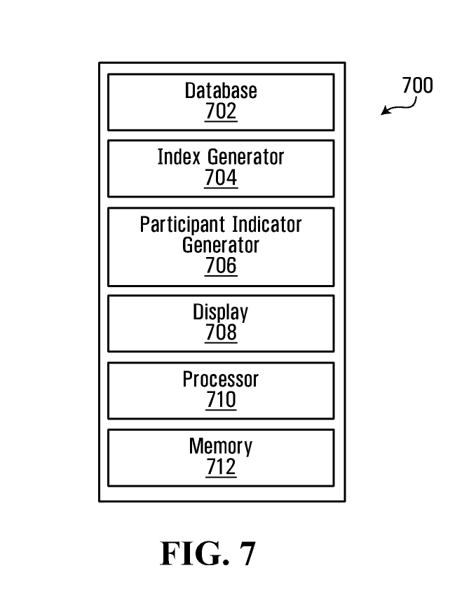

FIG. 7 is a block diagram of an example apparatus 700 that may generate and display numerical days in an electronic calendar in accordance with the method of FIG. 6. The apparatus 700 includes a database 702, an index generator 704, a participant indicator generator 706, a display 708, a processor 710 and a memory 712. The database 702 may store calendar data such as calendar data. The index generator 704 may be similar to the index generator 502 shown in FIG. 5. The participant indicator generator 706 may generate a visual indication of the number of participants of calendar events for each day. The display 708 may display numerical days for a given date range such as a month. Each numerical day may have a respective font size and bold type determined by an index generated by the index generator.

The index generator 704 may be implemented as a processor configured to perform the index generating functions described above. The index generator 704 may be implemented as a memory (such as the memory 712) containing instructions for execution by a processor (such as the processor 710), by hardware, or by a combination of instructions stored in a memory and additional hardware, to name a few examples.

The visual indicator may be generated as an “absolute” value or a “relative” value. A “relative” visual indicator, for a given date, may be generated as a function of both the index for that day and the indices of other days in the month. For example, the visual indicator may be generated based on how the index for the given date compares to other indices for the month. As a more specific example, the day(s) having the maximum and minimum duration of events could always be shown in the maximum and minimum font size and bold type respectively. Thus, a total duration of two hours in calendar events could result in different visual indicators depending on how busy other days of the date range are. By contrast, “absolute” visual indicators generation methods would not depend on the indices generated for any other days. Thus, in a specific example, a total calendar event duration of two hours would result in the same visual indicator regardless of the how busy other days in the date range are.

FIG. 8 shows an example user interface 800 for displaying calendar information in accordance with some example embodiments. The user interface 800 shown in FIG. 8 includes a calendar view selection menu 802, a calendar view section 804, and a calendar daily summary section 806. In this example, the calendar view selection menu 802 may be used by a user to select between daily, weekly and monthly views. The monthly view is selected in FIG. 8.

In the calendar view section 804, numerical days for the entire month of October 2011 are shown. The numerical days have size and bold types determined as a function of calendar data as described above. In this example, the larger numerical days, such as “18” and “19” indicate that the user has more time scheduled for events designated as “busy” or “tentative”. The user interface example shown in FIG. 8 can be used for a user to indicate a selected date. As can be seen in FIG. 8, the date Oct. 19, 2011, has been selected. For example, the user may click on the “19” with a navigation means such as a touch screen, finger pad, mouse, etc.

In this example, further visual indicators showing the total time in all events, regardless of designated availability factors (free, busy, tentative etc.), are included. Specifically, empty, partially filled, or fully filled bars are included adjacent to each numerical day in the month. Examples of these bars are circled with dotted lines and indicated with reference characters 808, 810 and 812. The bar is filled in at variable portions along its height to represent times of the day in which calendar events are scheduled. Thus, bars that are mostly or totally filled in represent that events are taking place most or all of the available time of the day. By contrast, bars that are mostly unfilled indicate that most of the day is available and not scheduled for calendar events. Such additional visual cues, when generated based on different parameters then the original visual cue (i.e. the size and bold type of the numerical days in this example) may provide a more complete picture of the activity level of the user for a particular day. For example, if a user has several events designated as “free” during the day, this may not be represented in the size of the numerical day, but may be reflected in the additional bar.

In the daily summary section 806, information about calendar events for the selected date are shown. In this example, the user may select between “Schedule”, “Agenda”, and “People” views. The “Schedule” view may show a schedule for the selected date (e.g. a “daily” calendar view). The “Agenda” view, as shown, may include details for events including, but not limited to, start and end times, updates, organizer, participants, event types and topics to be discussed, contact information, etc. The “People” view may include “participant brief data”. For example, a “brief” containing information about participants of calendar events occurring on a certain date, or within a range of dates, may be provided to a user. A “brief” may be any report, outline, or summary of information. The term “participant brief” used herein refers to a report, outline, or summary of information focused on or relating to one or more participants of calendar events. The term “participant brief data” is used to describe data defining or relating to a participant brief. The participant brief data includes at least a list of the participants of the calendar events within the selected date range. For example, if the date range is a single day, the list may include all participants of calendar events scheduled to occur on that day. In some example embodiments participant data may also include data associated with one or more participants in the list. Participant brief data may or may not include information in addition to the list of participants and the context data.

In this example, the “Agenda” view is selected. With Oct. 19, 2011, selected in the calendar view section 804, the agenda for that day is displayed in the daily summary section. The agenda, in this example, includes a summary of events, including start and end times, location, organizer, contact info, people, etc. for events scheduled for that day.

In some example embodiments, statistics data may also be generated and displayed in the user interface. Example embodiments are not limited to the particular type of information shown in FIG. 8.

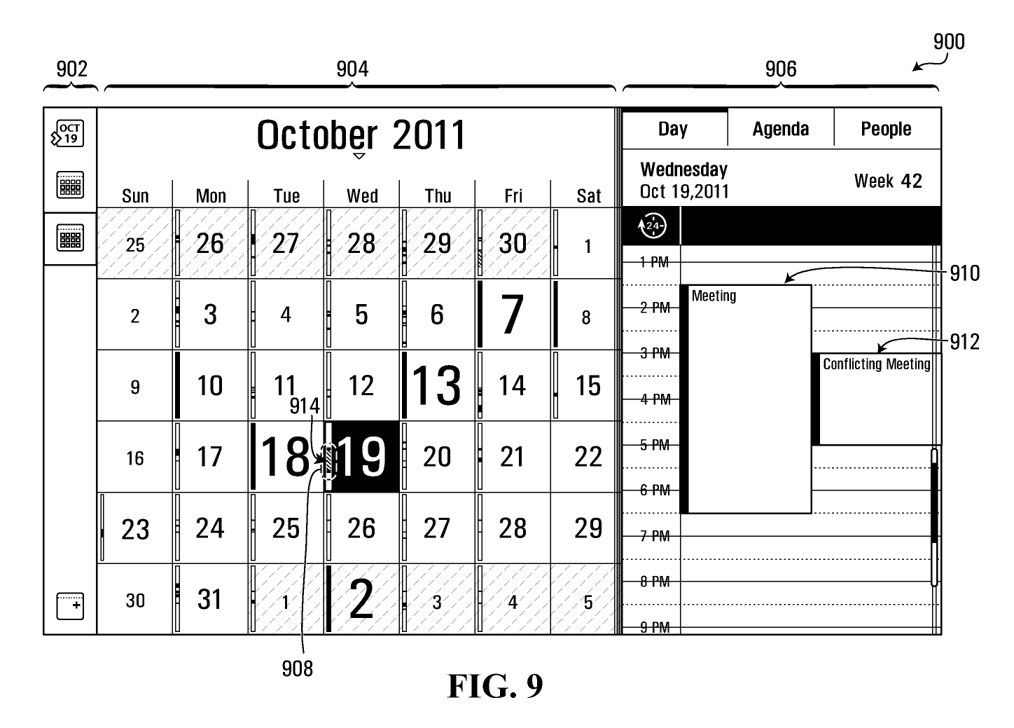

FIG. 9 shows another example user interface 900 for displaying calendar information in accordance with some example embodiments. In this example, a visual indicator includes a conflict indicator that indicates a conflict between two or more of the plurality of calendar events. The user interface 900 shown in FIG. 9 includes a calendar view selection menu 902, a calendar view section 904, and a calendar daily summary section 906, which are similar to the user interface 800 shown in FIG. 8. The calendar view section 904 shown in FIG. 9 also includes bars adjacent to each numerical day in the month similar to FIG. 8. An example bar is circled with a dotted line and indicated with reference character 908. In this example, the user may select between “Day”, “Agenda”, and “People” views in the daily summary section 906. The “Day” view is similar to the “Schedule” view option in FIG. 8. The “Day” view is shown in FIG. 9 and includes an hourly schedule of the day, where each event is displayed as occupying a portion of the day's time. In this example, a meeting 910 is scheduled from 1:30 pm to 6:30 pm. A conflicting meeting 912 is scheduled from 3:00 pm to 5:00 pm. The meetings 910 and 912 conflict because their scheduled times overlap.

The bar 908 indicating busy time for the day differs from the example bars 808, 810 and 812 shown in FIG. 8 in that it is wider and it includes a conflict indicator that indicates a conflict between two or more of the plurality of calendar events. In this example, the conflict is identified by a region 914 of the bar 908 that is shown as hatch pattern lines rather than solid. More generally, the region 914 identifying a conflict could be any color or pattern that is distinguishable from the remainder of the bar 908. Also, visual indicators are not limited to the bars shown in FIG. 9 and any suitable visual indicator that can allow for distinguishing busy, free and conflicting time for a day can be implemented. Conflicts may be determined in various ways. Events that overlap may be designated as conflicting. In some embodiments, travel time required to reach event locations may be taken into account such that events may conflict even if the actual scheduled times of the events do not overlap. Any two or more events that conflict may result in a corresponding visual indicator such as the region 914 of the bar 908 shown in FIG. 9. In some embodiments, one or more events or types of events may not be considered for the purposes of determining whether a conflict exists. For example, events flagged as “all day”, “free” and/or “out of office” events may not be considered. In some embodiments only events flagged as “tentative” or “busy” are considered for determining conflicts. In some embodiments, the number of participants is not relevant to determining conflicts. For example, events having no participants identified may still be considered. In some embodiments, events originating from different users' calendars may be considered for determining conflicts. For example, if calendar data for multiple users is consolidated, then the events for different users may be compared to determine whether any conflicts arise.

By using a visual indicator to show conflicts, a user may be able to quickly identify conflicts in their schedule. For example, if the color red is used in a visual indicator (such as the bar 908 in FIG. 9), a user with a very busy calendar with lots of double-booked meetings may see a lots of red in the monthly calendar.

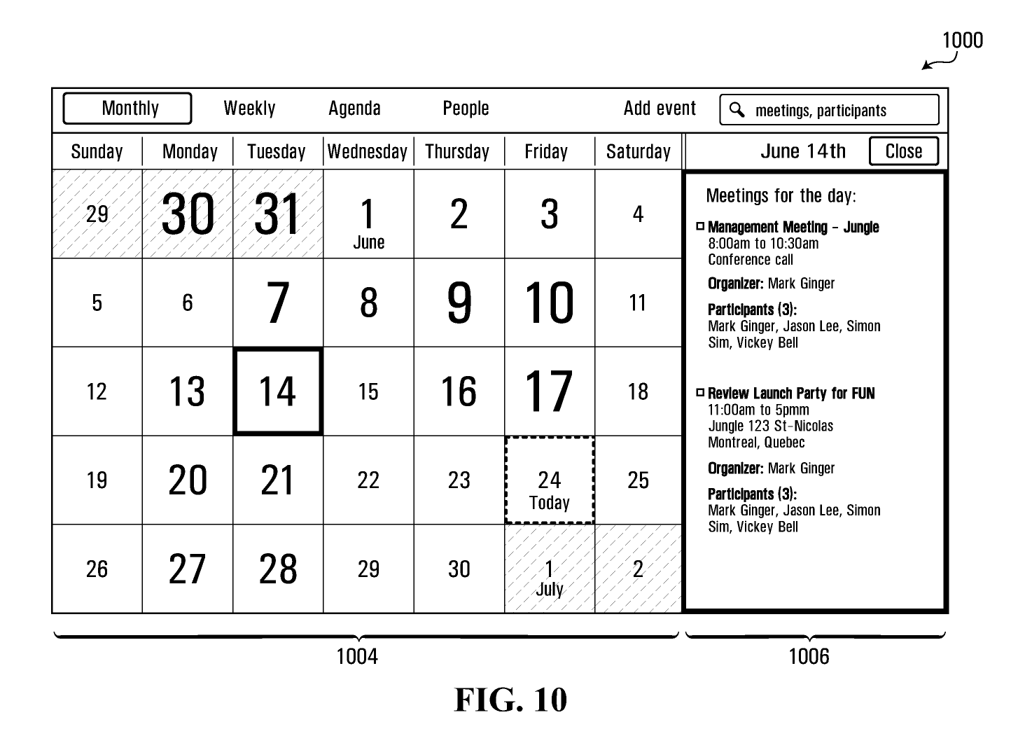

FIG. 10 shows another example user interface 1000 for displaying calendar information in accordance with some example embodiments. The example user interface 1000 shown in FIG. 10 includes a calendar view section 1004 and a daily summary section 1006. Numerical days for June are shown (as well as the 29th, 30th and 31st of May and the 1st and 2nd of July) in monthly calendar view section 1004. Again, the size and boldness of the numerical days indicate how busy a user is on those days. The daily summary section 1006 includes details for events of the selected date. In this example, the selected date is June 14. The user interface 1000 also indicates the current date with a dashed line around the perimeter of the area for the current date (June 24 in this example).

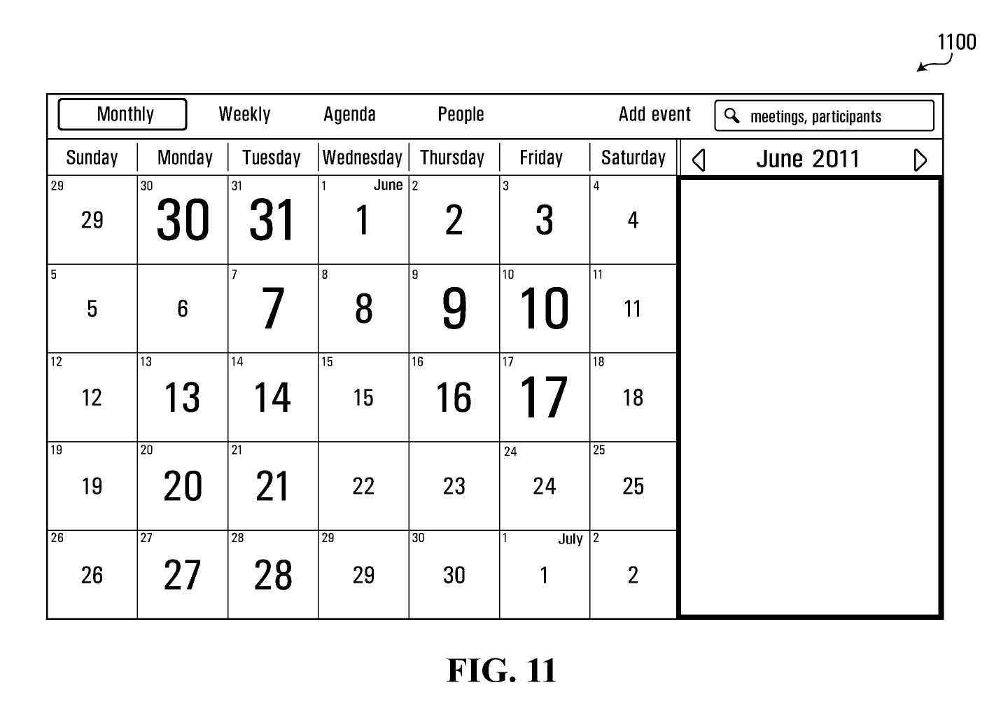

FIG. 11 shows another example user interface 1100 for displaying calendar information in accordance with some example embodiments. The user interface 1100 shown in FIG. 11 is similar to the user interface 1000 shown in FIG. 10. In the interface 1000 displayed in FIG. 10, the visual indicator displayed for each date is the font size only, and not the bold type, of the respective numerical day. No particular date has been selected in the example of FIG. 11, and thus, no daily summary information is shown.

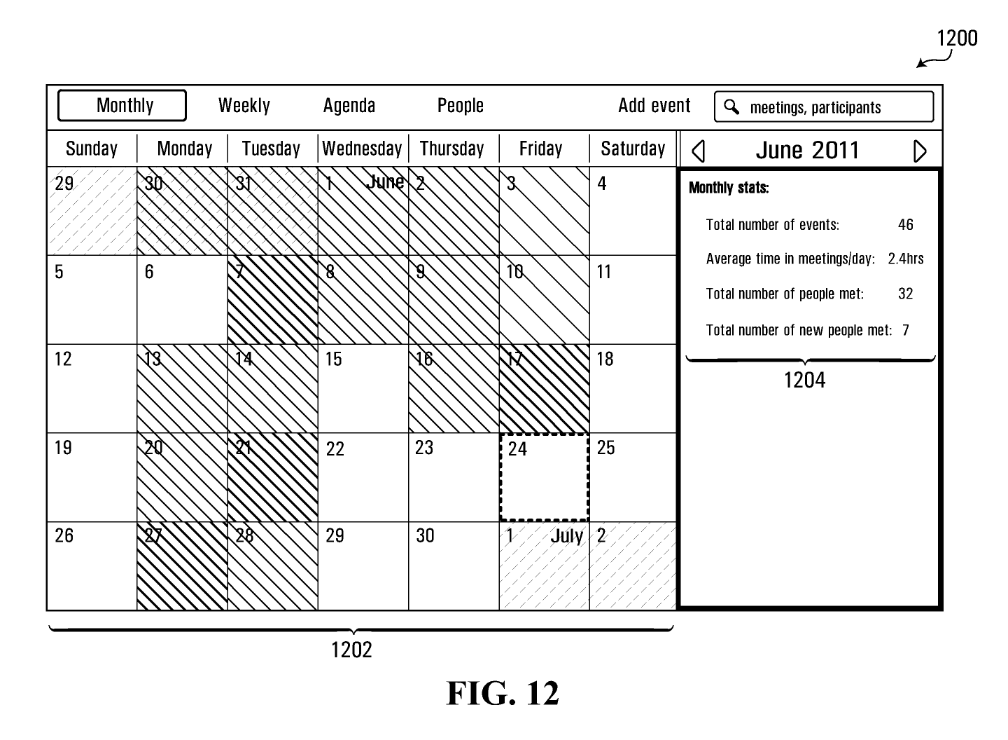

FIG. 12 shows another example user interface 1200 for displaying calendar information in accordance with some example embodiments. The user interface 1200 shown in FIG. 12 is similar to those of FIGS. 10 and 11. However, the visual indicator used in the calendar view section 1202 in this example is not the font size or bold type. Instead, in this example, the visual indicator is shading level of a grid block for each day of the month. The shading level is shown in FIG. 12 using various types of diagonal lines, although one skilled in the art will understand that shading may typically be shown using various shades of one or more colors, such as grey. FIG. 12 also shows a statistics section 1204 where statistics data generated as a function of calendar data for the month is displayed.

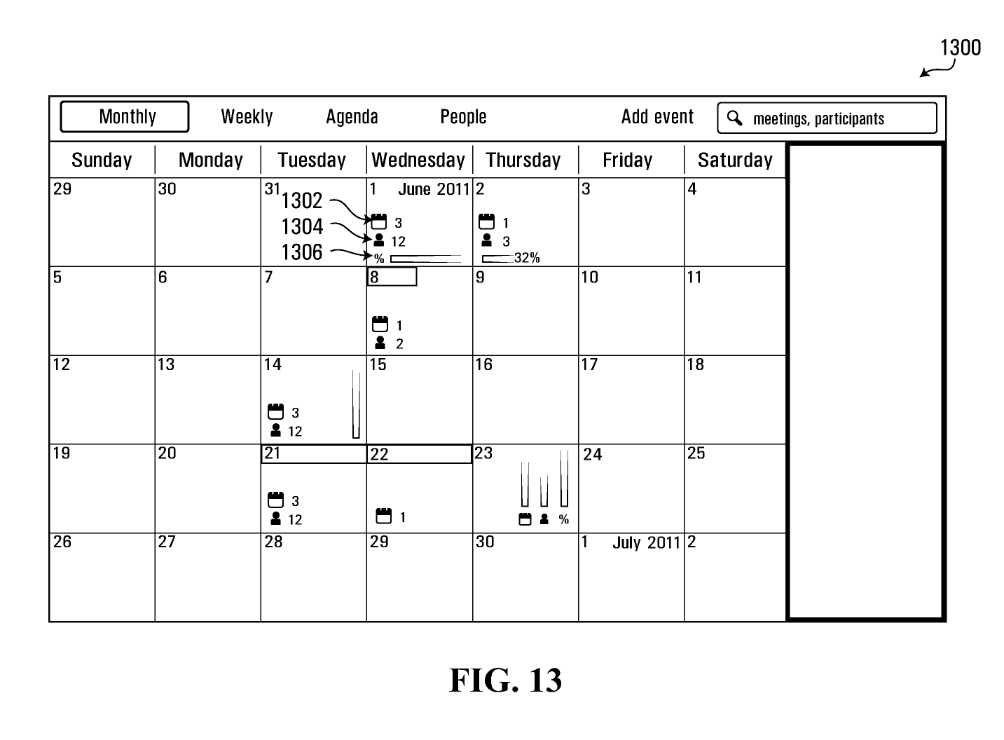

FIG. 13 is another example user interface 1300 for displaying calendar information in accordance with some example embodiments. FIG. 13 shows examples of further visual indicators. For example, for day 1, event number indicator 1302, participant indicator 1304 and percentage bar 1306 are shown. Event number indicator 1302 shows the number of events scheduled for the day. Participant indicator 1304 shows the number of participants that day. The percentage bar 1306, in this example, shows the percentage of available time of the day that is scheduled for calendar events (possibly only “busy” or “tentative” events). The percentage bar indicator may be generated as a function of calendar data in the same way that the index described above is generated. The percentage bar may also be generated as a function of the index described above. Other arrangements of similar indicators, including bars, are shown in days 14 and 23 in FIG. 13.

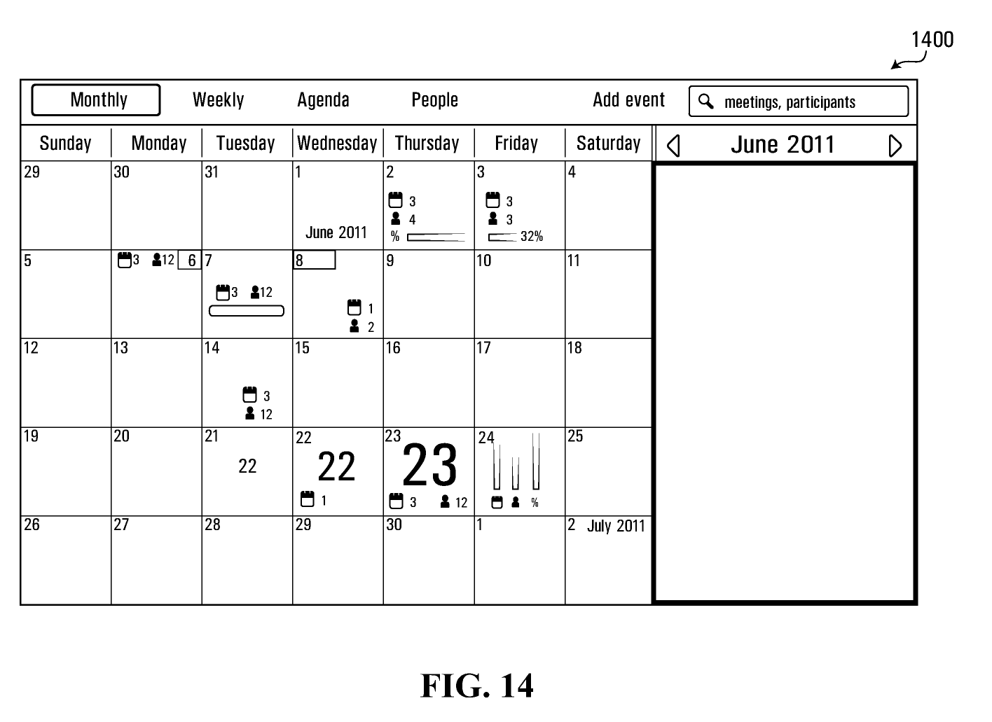

FIG. 14 shows another example user interface 1400 for displaying calendar information in accordance with some example embodiments. The user interface 1400 shown in FIG. 14 is similar to the example shown in FIG. 13, except that the example in FIG. 14 adds the font size type indicator for each numerical day as shown in FIGS. 8, 10 and 11.

In some example embodiments, the apparatus collects calendar data from multiple sources/databases for storing as aggregate calendar data and for processing the aggregate calendar data centrally. In some example embodiments, calendar data from multiple sources may be synchronized, either by the apparatus. For example, calendar data from any of the following sources may be synchronized: GOOGLE TOOLBAR™; OUTLOOK™; EXCHANGE™; DOMINO™; LOTUS™; NOTES™; iCAL™; ENTOURAGE™; WINDOWS LIVE™; YAHOO!™; CALENDAR™; FACEBOOK CALENDAR EVENTS™; and TRIPIT™. One skilled in the art will appreciate that calendar data that is synchronized may also be from other sources not identified herein.

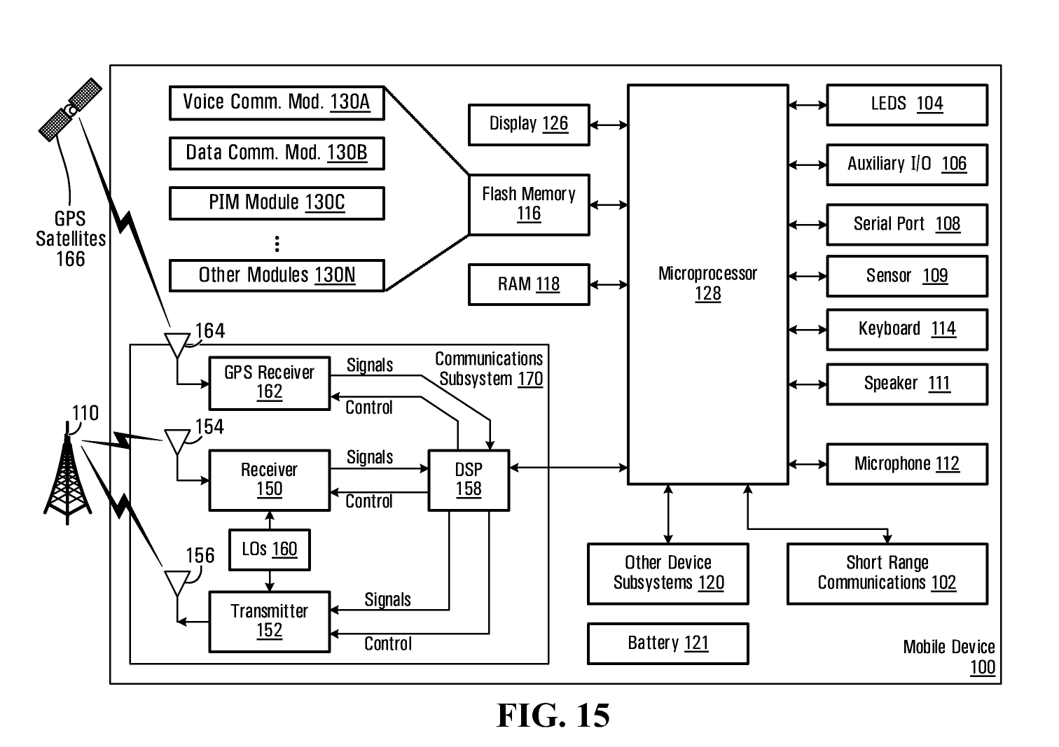

FIG. 15 shows block diagram a mobile device (also referred to herein as a client device or a mobile communication device) 100 that may implement the methods described herein. The mobile device 100 is shown with specific components for implementing features similar to those of the apparatuses 300, 500 or 700 shown in FIGS. 3, 5 and 7 respectively. It is to be understood that the mobile device 100 is shown with very specific details for example purposes only.

The mobile device 100 has a housing that may be elongated vertically, or may take on other sizes and shapes (including clamshell housing structures).The keyboard 114 may include a mode selection key, or other hardware or software for switching between text entry and telephony entry. Alternatively, the mobile device 100 may have a housing that does not take on other sizes and shapes.

A microprocessor 128 is shown schematically as coupled between a keyboard 114 and a display 126. The microprocessor 128 is a type of processor with features similar to those of the processors 306, 506 or 710 of the apparatuses 300, 500 or 700 shown in FIGS. 3, 5 and 7 respectively. The microprocessor 128 controls operation of the display 126, as well as overall operation of the mobile device 100, in response to actuation of keys on the keyboard 114 by a user.

In addition to the microprocessor 128, other parts of the mobile device 100 are shown schematically. These include: a communications subsystem 170; a short-range communications subsystem 102; the keyboard 114 and the display 126, along with other input/output devices including a set of LEDs 104, a set of auxiliary I/O devices 106, a serial port 108, a speaker 111 and a microphone 112; as well as memory devices including a flash memory 116 and a Random Access Memory (RAM) 118; and various other device subsystems 120. The mobile device 100 may have a battery 121 to power the active elements of the mobile device 100. The mobile device 100 is in some example embodiments a two-way radio frequency (RF) communication device having voice and data communication capabilities. In addition, the mobile device 100 in some example embodiments has the capability to communicate with other computer systems via the Internet.

Operating system software executed by the microprocessor 128 is in some example embodiments stored in a persistent store, such as the flash memory 116, but may be stored in other types of memory devices, such as a read only memory (ROM) or similar storage element. In addition, system software, specific device applications, or parts thereof, may be temporarily loaded into a volatile store, such as the RAM 118. Communication signals received by the mobile device 100 may also be stored to the RAM 118.

The microprocessor 128, in addition to its operating system functions, enables execution of software applications on the mobile device 100. A predetermined set of software applications that control basic device operations, such as a voice communications module 130A and a data communications module 130B, may be installed on the mobile device 100 during manufacture. In addition, a personal information manager (PIM) application module 130C may also be installed on the mobile device 100 during manufacture. The PIM application is in some example embodiments capable of organizing and managing data items, such as e-mail, calendar events, voice mails, appointments, and task items. The PIM application is also in some example embodiments capable of sending and receiving data items via a wireless network 110. In some example embodiments, the data items managed by the PIM application are seamlessly integrated, synchronized and updated via the wireless network 110 with the device user's corresponding data items stored or associated with a host computer system.

Additional software modules, illustrated as another software module 130N, may be installed during manufacture. The software modules may include, for example, the index generators 502 or 704 of FIGS. 5 and 7, the visual indicator generator 302 of FIG. 3 or the participant indicator generator 706 of FIG. 7 respectively. Note that the implementations described with reference to FIG. 15 are very specific for example purposes. For example, alternative implementations are possible in which the information updater is not implemented as software and stored on the flash memory 116. More generally, the information updater may be implemented as software, hardware, firmware, or any appropriate combination thereof.

Communication functions, including data and voice communications, are performed through the communications subsystem 170, and possibly through the short-range communications subsystem 102. The communications subsystem 170 includes a receiver 150, a transmitter 152, a GPS receiver 162, and one or more antennas, illustrated as a receive antenna 154, a transmit antenna 156, and a GPS antenna 164. In addition, the communication subsystem 170 also includes a processing module, such as a digital signal processor (DSP) 158, and local oscillators (LOs) 160.

The specific design and implementation of the communications subsystem 170 is dependent upon the communication network in which the mobile device 100 is intended to operate. For example, the communications subsystem 170 of the mobile device 100 may be designed to operate with the Mobitex™, DataTAC™ or General Packet Radio Service (GPRS) mobile data communication networks and also designed to operate with any of a variety of voice communication networks, such as Advanced Mobile Phone Service (AMPS), Time Division Multiple Access (TDMA), Code Division Multiple Access (CDMA), Personal Communications Service (PCS), Global System for Mobile Communications (GSM), etc. Examples of CDMA include 1× and 1× EV-DO. The communication subsystem 170 may also be designed to operate with an 802.11 Wi-Fi network, or an 802.16 WiMAX network or both. Other types of data and voice networks, both separate and integrated, may also be utilized with the mobile device 100.

Network access may vary depending upon the type of communication system. For example, in the Mobitex™ and DataTAC™ networks, mobile devices are registered on the network using a unique Personal Identification Number (PIN) associated with each device. In GPRS networks, however, network access is typically associated with a subscriber or user of a device. A GPRS device therefore typically has a subscriber identity module, commonly referred to as a Subscriber Identity Module (SIM) card, in order to operate on a GPRS network.

When network registration or activation procedures have been completed, the mobile device 100 may send and receive communication signals over the communication network 110. Signals received from the communication network 110 by the receive antenna 154 are routed to the receiver 150, which provides for signal amplification, frequency down conversion, filtering, channel selection, etc., and may also provide analog to digital conversion. Analog-to-digital conversion of the received signal allows the DSP 158 to perform more complex communication functions, such as demodulation and decoding. In a similar manner, signals to be transmitted to the network 110 are processed (e.g., modulated and encoded) by the DSP 158 and are then provided to the transmitter 152 for digital to analog conversion, frequency up conversion, filtering, amplification and transmission to the communication network 110 (or networks) via the transmit antenna 156.

In addition to processing communication signals, the DSP 158 provides for control of the receiver 150, the transmitter 152, and the GPS receiver 162. For example, gains applied to communication signals in the receiver 150 and the transmitter 152 may be adaptively controlled through automatic gain control algorithms implemented in the DSP 158.

In a data communication mode, a received signal, such as a text message or web page download, is processed by the communication subsystem 170 and is input to the microprocessor 128. The received signal is then further processed by the microprocessor 128 for an output to the display 126, or alternatively to some other auxiliary I/O devices 106. A device user may also compose data items, such as e-mail messages, using at least one of the keyboard 114 and some other auxiliary I/O device 106, such as a touchpad, a rocker switch, a thumb-wheel, or some other type of input device. The composed data items may then be transmitted over the communication network 110 via the communication subsystem 170.

In a voice communication mode, overall operation of the device is substantially similar to the data communication mode, except that received signals are output to a speaker 111, and signals for transmission are generated by a microphone 112. Alternative voice or audio I/O subsystems, such as a voice message recording subsystem, may also be implemented on the mobile device 100. In addition, the display 126 may also be utilized in voice communication mode, for example, to display the identity of a calling party, the duration of a voice call, or other voice call related information.

Location determination using GPS technology involves receiving GPS signals from GPS satellites 166 on the antenna 164. The GPS signals are received using the GPS receiver 162 and processed by the DSP 158. Typically, GPS signals from at least four satellites are processed. Further details of GPS are omitted for simplicity.

The short-range communications subsystem 102 enables communication between the mobile device 100 and other proximate systems or devices, which need not necessarily be similar devices. For example, the short range communications subsystem may include an infrared device and associated circuits and components, or a Bluetooth™ communication module to provide for communication with similarly-enabled systems and devices.

According to some example embodiments, a computer-readable medium is provided having computer-executable instructions stored thereon that, when executed, cause a computer to implement any one of the methods described herein.

The methods described herein are provided as examples. The various functions of blocks of the method flowcharts shown in the Figures and described above may be performed in different orders than described above. Furthermore, in some example embodiments, various blocks of the methods described above may be omitted.

While some specific example embodiments have been described above and illustrated in the accompanying drawings, it will be evident to those skilled in the art that modifications may be made without departing from this disclosure. Such modifications are considered as possible variants included in the scope of the disclosure.

1. A method implemented by a processor, comprising:
generating, for each date in a date range, an index as a function of calendar data, the calendar data including data items that indicate a date for a calendar event and a total time occupied by the calendar event; and
displaying a visual indicator as a function of the index, wherein the index represents, for each date, at least one of: a number of events for the date; and the total time occupied by the number of events for the date.

2. The method of claim 1, wherein the visual indicator comprises, for each date, a respective font setting of a respective numerical day, the font setting being determined as a function of the calendar data.

3. The method of claim 2, wherein, for each numerical day, the respective font setting comprises a respective font size.

4. The method of claim 2, wherein, for each numerical day, the respective font setting comprises a respective bold type.

5. The method of claim 1, wherein:
the calendar data further comprises, for each calendar event: a respective data item indicating an availability factor of the event; and
generating the index as a function of the calendar data comprises generating the index as a function of the total time occupied by the number of events for the date and the availability factor of each event for the date.

6. The method of claim 5, wherein the availability factor indicates that the event is designated as one of free, busy, tentative, and out-of-office.

7. The method of claim 6, wherein generating the index as a function of the calendar data comprises generating the index as a function of a total time occupied by the events designated as either busy or tentative.

8. The method of claim 1, wherein the calendar data further comprises, for each of at least one calendar event: at least one data item indicating at least one participant for the event.

9. The method of claim 8, further comprising, for each date, displaying a participant indicator generated as a function of a number of participants of events for the date.

10. The method of claim 1, wherein the at least one calendar event comprises a plurality of calendar events, and the visual indicator comprises a conflict indicator that indicates a conflict between two or more of the plurality of calendar events.

11. The method of claim 1, further comprising receiving the calendar data from a database.

12. The method of claim 11, wherein the calendar data that is received comprises a portion of available calendar data.

13. The method of claim 12, wherein the portion of the available calendar data comprises data items upon which the index is based.

14. The method of claim 12, wherein
the calendar data further comprises, for each calendar event: a respective data item an availability factor of the event, and
the portion of the available calendar data comprises the data items indicating: the date of the event; the total time occupied by the event;
and the availability factor of the event.

15. The method of claim 14, further comprising receiving an indication of a selected date in the date range and receiving additional data items for events for the selected date.

16. An apparatus, comprising:
a processor configured to generate, for each date in a date range, an index as a function of calendar data, the calendar data including data items that indicate a date for a calendar event and a total time occupied by the calendar event; and
a display displaying a visual indicator as a function of the index, wherein the index represents, for each date, at least one of: a number of events for the date; and the total time occupied by the number of events for the date.

17. The apparatus of claim 16, wherein the visual indicator comprises, for each date, a respective font setting of a respective numerical day, the font setting being determined as a function of the calendar data.

18. The apparatus of claim 17, wherein for each numerical day, the respective font setting comprises at least one of a font size and a bold type.

19. The apparatus of claim 16, wherein
the calendar data further comprises, for each calendar event: a respective data item indicating an availability factor of the event, and,
generating the index as a function of the calendar data comprises generating the index as a function of the total time occupied by the number of events for the date and the availability factor of each event for the date.

20. A computer-readable medium having processor-executable instructions stored thereon that, when executed by a processor, cause the processor to implement a method comprising:
generating, for each date in a date range, an index as a function of calendar data, the calendar data including data items that indicate a date for a calendar event and a total time occupied by the calendar event; and
displaying a visual indicator as a function of the index, wherein the index represents, for each date, at least one of: a number of events for the date; and the total time occupied by the number of events for the date.
